(19) United States
(12) Patent Application Publication
(10) Pub. No.: US 2006/0235749 A1
(43) Pub. Date: Oct. 19, 2006

(54) Network marketing system

(76) Inventor: Peter Chi Phu Moc, Monterey Park, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/369,533

(22) Filed: Mar. 7, 2006

Related U.S. Application Data
(60) Provisional application No. 60/671,776, filed on Apr. 15, 2005.

(51) Int. Cl. G06Q 30/00

(52) U.S. Cl. 705/14

(57) ABSTRACT

A multi-level marketing system uniting businesses and individuals as a team to help each other to earn monetary rewards based on sales and profit sharing (optional feature) as governed by a simple yet customizable compensation plan that is tailored to maximize sales.

### CROSS REFERENCE TO RELATED APPLICATIONS

The Applicant claims the benefit of his prior Provisional Application, Serial No. 60/671,776, filed Apr. 15, 2005.

### BACKGROUND OF THE INVENTION

(1) Field of the Invention

The present invention relates to the field of marketing and more particularly to the field of network marketing systems with optional profit sharing feature by which members with or without any item to sell can cross promote to maximize sales for monetary compensation.

(2) Description of the Related Art

Network marketing has always proven to be the most cost effective way to get products and services to the consumers. However, many small businesses cannot afford the time and cost associated with developing a workable marketing system and do not have the energy and knowledge to start it up from scratch. Furthermore, they end up with a system that eventually becomes exhausted in marketing only a few product lines. Individuals would have to jump from one marketing system to the next or participate in a few systems in order to make more money. Other companies put in place a multi-level marketing system to promise great monetary gain for being on the ground level but become illegal pyramid schemes. See “The Legal ABC's of MLM” by attorney Gerald P. Nehra, published at http://www.mlmstartup.com/articles/abc-art.htm. Their incentives are focused on membership fees rather than selling and the structural payout is complicated and boring to follow.

For example, U.S. Pat. No. 6,421,648 to Gagnon, et al. describes a data processing system for monitoring and recording the information flow and data, and making all calculations necessary for maintaining a Differential Continuous Compensation Plan (DCCP) for participants to a Multi-Level Marketing approach (MLM). MLM is defined as “an approach that remunerates participants for the purchases made by the people that they directly and indirectly introduced to particular products and/or services.” It is very complicated to say the least.

What is needed is multi-level marketing system that has a compensation plan which rewards every member, whether new or old, the same way based on sales volume so that when a member joins the system does not matter. Development of a multi-level marketing system which can reward every member in the same way based on sales volume represents a great improvement in the field of multi-level marketing and satisfies a long felt need of small businesses and individuals.

### SUMMARY OF THE INVENTION

The present invention is a multi-level marketing system that has a compensation plan which rewards every member, whether new or old, the same way based on sales volume so that when a member joins the system does not matter. For the first time, members can team up to promote all the products or services on the network whether or not they are theirs and to earn monetary compensations for simply shopping or referring new and even old customers. The system is customizable and very easy to explain, and to be understood by new members. It is based on receiving commissions for all sales except for every preset number of sales a downline member must pass it up to an upline member. Instead of recruiting, members actually benefit more from making a sale to another member, because that member then acquires not only that purchasing member as a downline member but all the downline members that that member brings with him or her. Sales are encouraged even more when implementing the optional profit sharing feature. A member making a purchase can participate in the income generated by the company that is employing this system.

An appreciation of the other aims and objectives of the present invention and an understanding of it may be achieved by referring to the accompanying drawings and description of a preferred embodiment.

### BRIEF DESCRIPTION OF THE DRAWINGS

FIG. 1 is a flowchart illustrating the overall outline of the system of this invention with optional profit sharing.

FIG. 2 is a chart illustrating the relationships between generations of members and non-members and what each class of individuals is allowed to do on the system.

FIG. 3 is a flowchart illustrating the promotional side of a listing of products and services for sale.

FIGS. 4 and 5 are a flowchart illustrating how transactions are processed at checkout.

FIG. 6 is a flowchart illustrating the overall outline of the system of this invention without optional profit sharing.

### DETAILED DESCRIPTION OF THE PREFERRED EMBODIMENT

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

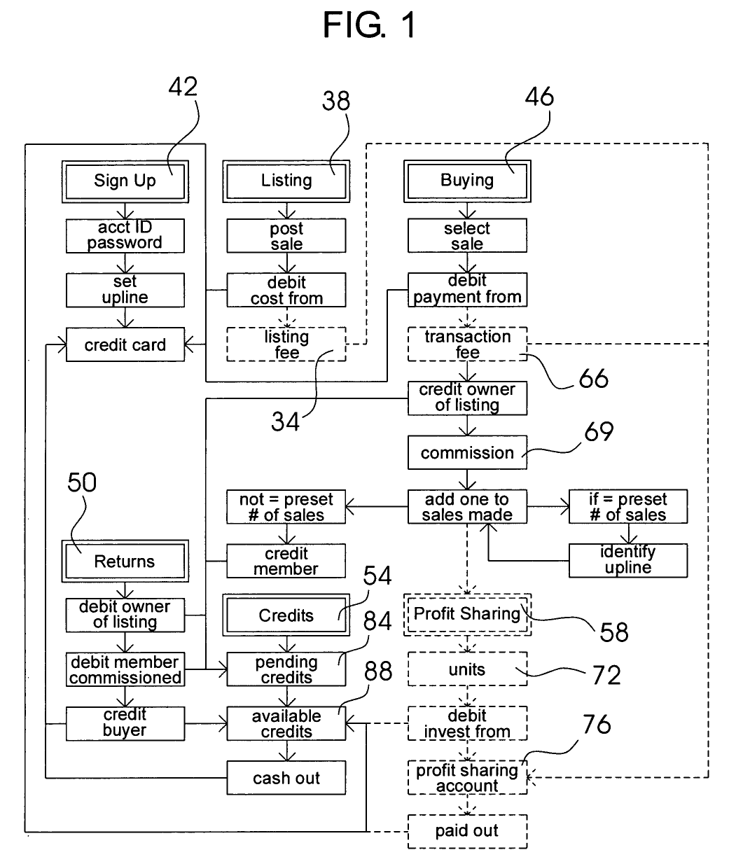

Referring to the Figures, double lined boxes represent the features of the system and single lined boxes represent the elements important to that part of the system. The down arrows show the general flow of the processes and two arrows going away from the side(s) of a box reveal an optional path that a task can be carried out. The dotted lines represent the workings of the optional profit sharing feature. FIG. 1 graphically illustrates the overall process of this system. It shows how the elements and features of the system are related to each other and how each step of the process is executed. The steps necessary for signing up 42, listing an item for sale 38, buying an item 46, making returns 50, handling credits 54 and handling the optional profit sharing feature 58 are detailed on FIG. 1.

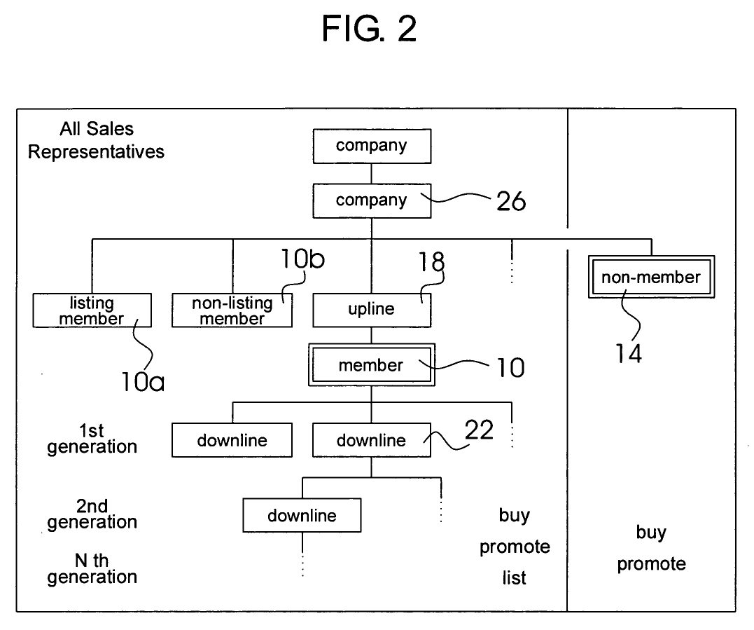

This improved multi-level marketing system consists of many important features, key elements, and relationships. FIG. 2 shows the relationships among members 10. First, there are members 10 and non-members 14. Non-members 14 cannot make any listings without first becoming members 10, but members 10 can either be listing members 10a or non-listing members 10b depending on if they have anything to sell. The two structural elements for each and every member 10 are upline 18 and downline 22. An upline 18 is a member 10 who receives monetary benefits from another member 10 who is downline 22 in hierarchy. Each member 10 can have only one upline 18. Each member 10 on the other hand can have an unlimited number of downlines 22. Each step in the hierarchy is defined as a generation. The company 26 is the only member 10 who has itself as an upline 18.

All members 10, new and old are sales representatives operating under the same compensation plan that rewards them based on sales volume. There are no monetary advantages to joining the system early and recruiting a big team if no one makes a sale. For a member 10, “making a sale” can mean buying something for himself or it can mean selling something to others in which case the member 10 gets a commission 69, except if the buyer decides to join in the process (see “Buying” 46 on FIG. 1). In that case, the buyer becomes a member 10 too and therefore keeps the commission 69 for his own purchase. The referring member 10 now has the new member 10 as his downline 22. After a preset number of sales that the downline member 22 makes, directly or indirectly, a commission 69 is paid to the upline member 18 (see “Buying” 46 on FIG. 1). For example, suppose the preset number of sales is five. The downline 22 makes four sales from which he keeps the commissions 69. But on the fifth sale, regardless if he makes the purchase for himself or the purchase is from a referred non-member 14, the commission 69 goes to the upline 18; unless the upline 18 too is on his fifth sale, then the commission 69 goes to the upline's 18 upline 18. Likewise, that commission 69 stays only with the upline 18 who is not on his preset number of sales. So all the other uplines 18 involved get compensated for the sale made. As is clearly evident in FIG. 1, a loop is created whenever a commission 69 happens to fall on that preset number of sales by any and all members 10. Eventually, members 10 will catch on that in order to secure all possible huge commissions 69 from downlines 22, they need to first satisfy every fifth sale with a small purchase of their own. They are purposely giving up a small commission 69 in hopes that the next commission 69 they receive from any downline 22 would be greater. In order to ensure an interesting exchange, the company 26 needs to set a minimum sales price for all postings. Chasing the preset number of sales with a purchase is the main driving force of the system. In effect, more sales occur and those who buy more have the opportunity to earn even more.

Another very important feature of the system is the upline 18 is never fixed. Instead it changes with every referral purchase. The only exception being that the company 26 that is employing this system always has itself as an upline 18 so that ultimately no commission 69 passes. If a member 10 makes a purchase through the referral of another member 10, then the referring member 10 becomes the new upline 18 for this buying member. The upline 18 not only acquires a new downline 22 but all the downline's 22 downlines 22 as well. This is a huge incentive for members 10 to promote sales to other members 10 and not necessarily to hunt for new members 10. Since everything is based on sales and not new recruits, a member 10 will never “run out of gas” simply because everyone he knows has already joined the system. A new member 10 can make a sale from a very long established member 10 and receive all his downlines 22. Similarly there is no guarantee that this long established member 10 has a huge downline 22 if he does not constantly make new sales to other members 10.

A sale is a unit of purchase which equals a single listing, a posting, or advertisement (ad). See “Listing” 38 on FIG. 1. All basic information in an ad, like description, sales tax, shipping charge, and return policy can be updated anytime by the listing member 10a, except the sales price always has to meet the minimum. There is also a minimum on the listing duration. The listing fee 34 is based on the duration, the look of an ad, and the location of an ad. The listing fee 34 goes to the company's 26 account and is non-refundable and fixed for the entire listing duration. Any changes to the cost of listings will apply to the next cycle. Members 10a can choose to list more than one item or several different products or services in a single ad and have it be considered as one sale. For every sale, money is split three ways: sales tax and shipping charge (if any) along with a big percentage of the sales price go to the owner of the listing, a smaller percentage for the commission 69, and an even smaller percentage for the transaction fee 66. The transaction fee 66 going to the company's 26 account is non-refundable whereas most of the sales price plus any sales tax and shipping charge go back to the buyer who chooses to make a return (see “Returns” 50 on FIG. 1) within a specified time period. That time depends on the delivery time and the length of the return policy plus a grace period. Credits from a sale do not become available until the time allowed for the return expires. See “Credits” 54 on FIG. 1. Pending credits 84 from both the owner of the listing and the sales representative who earned the commission 69, which often time is the owner too, are deducted as returns are made. They revert back as available credits 88 for the buying member 10 or are charged back to the credit card of a non-member 14. Available credits 88 can go toward paying for future purchases or listings so that members 10 do not have to use their credit cards every time. In fact, members 10 who actively participate in the system will find that they no longer need to use their credit cards to pay for purchases after a while.

Additionally, the company 26 can choose to integrate profit sharing concepts 58 to provide more incentives for buyers to become members 10 and for members 10 to make more purchases. The profit sharing feature 58 is optional and not necessary for the rest of the system to work. Including this feature means a separate account is needed to hold and distribute these credits. The costs for listings and transactions are both revenues generated by the system so that the company 26 can choose to share them. Since profit sharing 58 is another way the company 26 rewards its buying members, the company 26 is not allow to participate in it. However, the company 26 has to buy the first profit sharing unit 72 to set the feature in motion. The first unit 72 establishes the minimum price for the next unit 72 and so forth. Once that unit 72 expires, the company 26 can not buy any more unless, if ever, the total number of outstanding units 72 drops to zero. Every member 10, except the company 26, who makes a purchase, has the option to buy profit sharing unit(s) 72 at the going price. The cost is added to the purchase and payment can come from available credits 88 or from a credit card. The company 26 employing this system can allow a certain amount of profit sharing units 72 to be sold for every one sale. It will also limit the life span of each unit 72 so that as each unit 72 expires it is automatically paid out at the current price from the profit sharing account 76 to the members 10 as available credits 88. The profit sharing account 76 consists of listing fees 34, transaction fees 66, and all profit sharing investments. An investment is basically the cost to own unit(s) 72. The price per unit 72 is determined by the profit sharing account balance 76 divided by the number of outstanding units 72.

$$price / unit = \frac{listing fees + transaction fees + profit sharing investments}{number of outstanding units}$$

Therefore, the price per unit 72 never decreases in value. As the number of outstanding units 72 fluctuates, so does the profit sharing investment. However, the listing fees 34 and the transaction fees 66 are independent of the number of outstanding units 72 and they can only increase. The price for a profit sharing unit 72 starts at a minimal predetermined amount and every time it goes past a higher predetermined amount then all the outstanding units 72 split. If the split is by two, then the price of each unit 72 is reduced by half and the number of outstanding units 72 doubles. In other words, every member 10 who owns unit(s) 72 now has twice as many but the price on each is half as much as before. This keeps the combined value of all profit sharing units 72 the same while encouraging more unit 72 purchases at a lower price. The company 26 can choose to retain some of its income by including only a percentage of the listing fees 34 and transaction fees 66 into the profit sharing account 76. Nevertheless, members 10 making purchases can participate in substantial profit of the company. They can transfer any amount of their available credits 88 to their credit cards. Members 10 can close their accounts at any time, but they automatically pass up all future commissions 69 from all downlines 22 to their uplines 18. Any outstanding profit sharing units 72 will be converted at the current price per unit 72 and then cashed out along with all available credits 88. This is the only time when the profit sharing units 72 are traded in before they expire. Also, any pending credits 84 become the property of the upline 18.

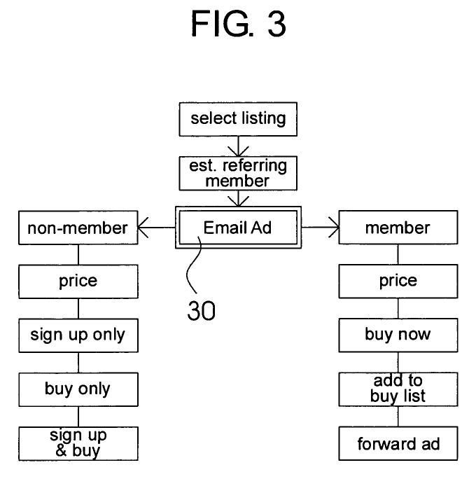

Naturally, implementation of this system will be via a web site on the Internet. The following is an example of this new multi-level marketing system as it is applied to an e-commerce website, although the invention is not limited to just this medium. The website goes well with detailing the system by showing how the features and elements work. It is best to describe them in the order that would explain the relative process a new user would go through. First, a non-member 14 can make purchases and promote just like a member 10 without having to become a member 10. All non-members 14 who make purchases are subject to the non-refundable transaction fee 66, but they enjoy the security of having only to disclose their credit card information to the company 26 employing the system and not to the millions of members 10a who have postings. Promotion is done through email ads 30. See FIG. 3. A user (member 10 or non-member 14) finds an item on the site and then emails it to another user. The email becomes an ad 30 with options for non-members 14: (1) sign up only to establish the referring member 10 as upline 18, (2) buy only to grant the commission 69 to the referring member 10, or (3) sign up and buy at members'10 price after receiving commission 69 and establishing the referring member 10 as upline 18. The email ad 30 also has options for members 10: (1) buy now at members'10 price after receiving commission 69 except for every preset number of sales and establish the referring member 10 as the new upline 18, or (2) add to buy list for automated purchases by the system for every preset number of sales, or (3) forward this ad 30 with the forwarding member 10 as the referring sales representative. A member 10 using the buy list has to specify the choices before activating it. He has to decide where the payment is coming from: (1) credit card only, or (2) available credits 88 only, or (3) credit card after using all available credits 88. He also needs to set the number of profit sharing units 72 to buy, from none up to the maximum allowed for each sale. Hence, the system helps him to chase every preset number of sales with a purchase that is next on his buy list. The email ad 30 shows the member 10 price and the non-member 14 price. It also shows who the referring sales representative is if it was sent out by a member 10. If the sender is a non-member 14, then it is like someone going directly to the company's 26 website to sign up. The default upline 18 will then be the company 26 that is employing this system. The monetary rewards will encourage membership for both the sender and the recipient. Free membership is established with a unique account identification like an email address and password for login onto the system from any computer with internet access. See “Sign Up” on FIG. 1.

When a member 10 logs on, he sees numerous counters reflecting the status of his account. All of which are constantly active even when the member 10 is offline. First and foremost is the downline 22 count. Every member 10 has a number associated with his account identification. That number represents how many members 10 are beneath him. It is simply the number of members 10 in his first generation downline 22 added to the sum of all his first generation downline's 22 associated numbers. That number changes as his downlines 22 come and go. A high number usually means more chances for receiving commissions 69 from indirect sales.

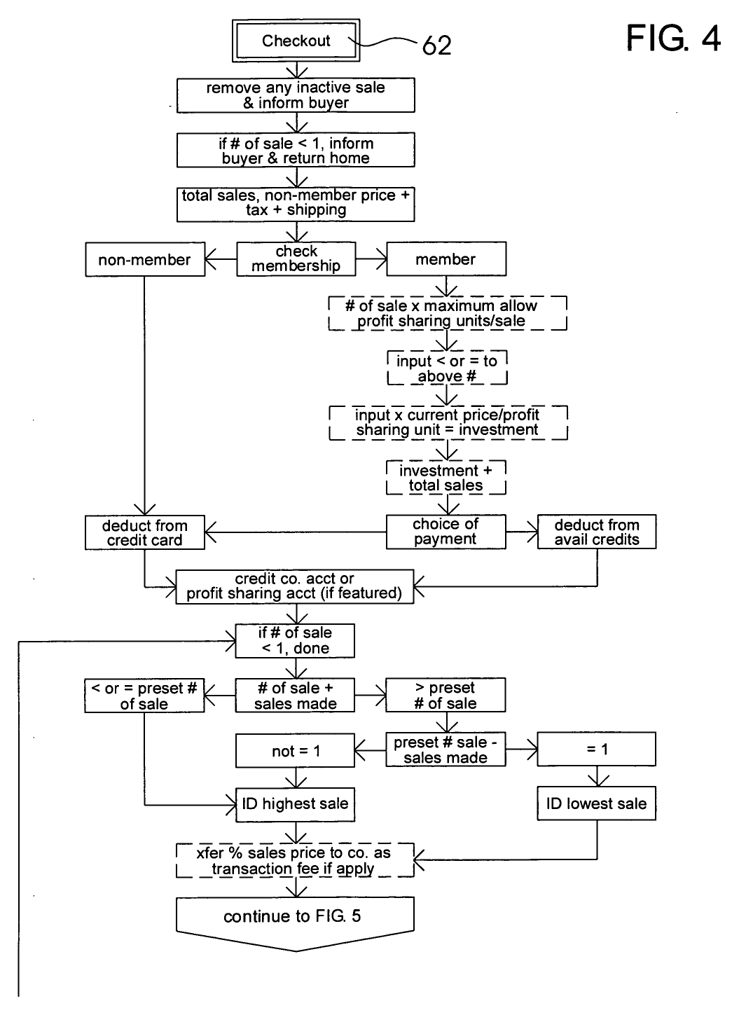

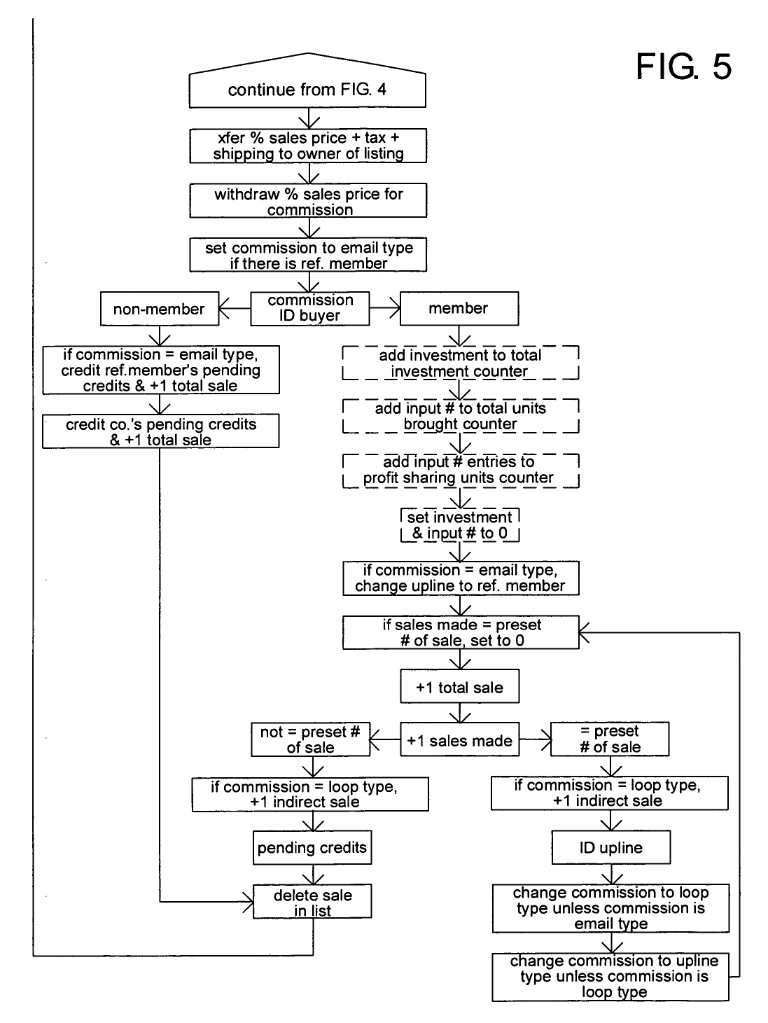

Since the whole system is based on sales, many of the other counters are sales related and therefore inherited into the checkout process 62. Each step of the checkout 62 details how the features and elements of the system are applied. See FIGS. 4 and 5. At checkout 62, the system looks first to remove any sale from the list that is inactive and informs the buyer. Members 10a are allowed to continue advertising their listings when they are temporarily out of stock, since their entire duration is already paid for. Otherwise, sales would be interrupted for potential buyers who have saved ads that no longer exist. Next, the system checks to see if the number of sales is less than one and if so it informs the buyer and returns to the homepage. Then, the system moves on to total up all the remaining sales by adding up all the non-member 14 prices plus their sales taxes and shipping charges if any. If the purchase is made by a non-member 14, then the sum is deducted from his credit card. A member 10 on the other hand has another way of paying for it if he has enough available credits 88. A member 10 also has an additional option before that. Assuming the company 26 has included the profit sharing feature 58 into the system, he has to decide on the number of profit sharing units 72 to buy if any. The steps for this sub-system are as follows: (1) multiply the number of sales on the list by the maximum number of units 72 allowed for each sale; (2) wait for an input by the member 10 which cannot be greater than the number resulting from step 1; (3) multiply the input by the current price per unit 72 to get the investment; and (4) add the investment to the total for the sales on the list. Payment from a buyer, member 10 or not, goes to the profit sharing account 76 separate from the company's 26 own account. If the company 26 excludes the profit sharing feature 58, then payments derived from the total of all sales without any added investments would go to the company's 26 account and all the steps represented by dotted lines in the flowchart can be omitted. See FIGS. 4 and 5.

Because the main compensation of the system is about giving up a percentage of all commissions 69, members 10 making a big sale would not want it to fall on the preset number of sales. Otherwise, they would have paid full non-member 14 price for that sale made. If a member 10 makes a purchase with multiple sales at one time, then the system will arrange the sale with the least sales price to be the preset number of sales. This gives the best possible commissions 69 back to the buying member 10. For this reason and also to identify the flow of credits for each sale separately in case of returns, the system continues with the checkout process 62 as follows. First, the system checks to see if the number of sales on the list is less than one and if so then returns to the homepage. Then, it adds the number of sales to the number of sales made, which defaults to zero for non-members 14 because it does not apply. If the sum is less than or equal to the preset number of sales, then the system identifies the sale with the highest sales price. It will randomly pick one if there are more than one sale at that price. However, if the sum is greater than the preset number of sales, then the system goes through an extra step. It needs to subtract the number of sales made from the preset number of sales. If the result is one, then the system identifies the sale with the least sales price. Again, if there are two or more at that price, then it will just keep the first one that it finds. If the result does not equal one, then the system identifies the sale with the highest sales price. With the information for each sale, the system proceeds to assign the credits that went to the profit sharing account 76 earlier. If the company 26 decides to keep a portion of the transaction fee 66, then it transfers a percentage of the sales price to the company's 26 non-sharing account. That percentage cannot be greater than the percentage predetermined as the transaction fee 66. For example, if the transaction fee 66 is 10% of the sales price and the company 26 wants to contribute 6% of it to the profit sharing feature 58 of the system, then it would take back 4% of the sales price. Next, the owner of the listing gets a percentage of the sales price plus any sales tax and shipping charges. It goes to his pending credits 84 and is tagged with the transaction ID in case a refund is necessary. Finally, a percentage of the sales price is withdrawn from the profit sharing account 76 as commission 69. If the identity of this particular sale includes a referring member 10, then the commission 69 is set as email type. The commission 69 goes through one of two paths. If it is a non-member 14 purchase, then the steps are as follows: (1) if commission 69 is email type, then place the commission 69 in the referring member's 10 pending credits 84 and add one to his total sales counter; otherwise (2) credit the pending credits 84 of the company 26 that is employing this system and add one to the company's 26 total sales counter; (3) delete sale from list; and (4) proceed back to the step where the system checks to see if there is any more sale on the list. If it is a member 10 purchase, then the other steps are as follows: (1) add investment if any to the total investments counter; (2) add input number if any to total units brought counter; (3) add input number of entries if any to profit sharing units counter; (4) reset investment and input number to zero; (5) if commission 69 is email type, then change upline 18 to referring member 10; (6) if the number of sales made equals the preset number of sales, then reset the sales made counter to zero; (7) add one to the total sales counter; (8) add one to the sales made counter. Then, depending on the resulting sales made number, there are two different sub paths. If the sales made number does not equal to the preset number of sales, then the steps are as follows: (1) if commission 69 is loop type, then add one to the indirect sales counter; (2) add commission 69 to pending credits 84; (3) delete sale from list; and (4) proceed back to the step where the system checks to see if there is any more sale on the list. If the sales made number equals the preset number of sales, then the steps are as follow: (1) if commission 69 is loop type, then add one to the indirect sales counter; (2) identify upline 18; (3) change commission 69 type to loop type unless commission 69 type is email type; (4) change commission 69 type to upline type unless commission 69 type is loop type; and (5) repeat all steps starting from the step that checks whether the sales made counter needs to be resetted. When the sales made counter becomes zero, it simply means that the member 10 is now on his first sale of the next cycle. The sales made counter is only concerned with the commission 69 side of a sale for distributing rewards and not how many times the owner of the listing has sold something. In fact, the owner can have a very low total sales number, which is commission 69 based also, while he possesses a lengthy pending credits 84 list. Since total sales are the combined sum of direct sales and indirect sales, the system automatically fills in the number of direct sales knowing the other two. After all credits from this sale have been transferred, the system will remove it from the list. The checkout process 62 continues on until all the credits from each sale on the list have been properly assigned and tracked. Thus, the system goes back to the step where it checks to see if the number of sales on the list is less than one and if so the checkout 62 is complete.

Pending credits 84 is a counter showing the total sum of all sales (commissions 69 & non-commissions) before they become available credits 88, which is another counter representing a member's 10 account balance with the system. Both are in monetary units. Pending credits 84 carries a list. Each entry on the list shows: (1) transaction ID, (2) type of commission 69 or otherwise non-commission, (3) time of availability, and (4) the amount in monetary units. As each entry becomes available, it is deleted from the list and the corresponding amount is added to the available credits 88. The type of commission 69 will determine where the amount is recorded. The indirect sales monetary counter is responsible for all loop type commissions 69 whereas all other commission 69 types belong to the direct sales monetary counter. These two counters add up to the total sales monetary counter. If it is a non-commission sale, then the amount is recorded to the listing revenue counter. These are sales amounts earned by the owner of listing(s). If a return is made, then the entries from the pending credits 84 of both the owner of the listing and the member 10 who received the commission 69 are deleted. Consequently, their available credits balance 88 and none of their reporting counters are affected. It is possible that both entries belong to the same member 10a. The owner of the listing can also be the sales representative who earned the commission 69. With the exception of the non-refundable transaction fee 66, credits from the sale plus any sales tax and shipping charge are reverted back to the buyer. The transaction ID tracks the buyer's information so that available credits 88 can go back to the member 10 or credits can be return to the credit card of a non-member 14.

The profit sharing units counter 72 is similar to the pending credits counter 84 in that it shows a member's 10 total number of outstanding units 72 with a list of time stamps. Each entry tells when the unit 72 was brought and when it will become available credits 88. As each unit 72 expires at the end of its predetermined life span, it is paid out at the current price per unit 72 from the profit sharing account 76. That amount is recorded by the counter showing the total value of expired units 72. Members 10 making returns on sales get to keep the profit sharing units 72 that they brought, if any.

Another way to understand this invention is through the following outline.
I. Structure
   A. non-members & members
      1. promote sales through email ads
      2. shop by credit card, which is kept private by the company and invisible even to the members selling the items
      3. non-refundable transaction fee (a percentage of the sales price)
   B. members (all sales reps)
      1. the company
         a. the only sales rep who has itself as an upline always
         b. buys the first profit sharing unit to set the optional profit sharing feature of the system in motion
         c. not allow to buy any more profit sharing units after the first
      2. sign up
         a. establish account ID & password
         b. referring sales rep becomes the floating upline (the company is the default)
         c. optional credit card info
      3. optional listing
         a. there is a minimum on sales price
         b. there is a minimum on duration
         c. deduct cost from available credits or credit card
         d. listing fee is non-refundable and fixed for the entire listing duration, although changes will be applied for the next cycle
      4. upline & downline
         a. an upline is the member who receives monetary benefits from another member who is the downline
         b. each member can have only one upline who in turns have another upline and so forth
         c. a member can have unlimited downlines and these downlines can have unlimited downlines such that each step down is a generation
         d. floating upline
            i. the sales rep who made a sale from a member establishes that member as his downline along with all the downlines that member brings
            ii. it represents the last sales rep who referred a sale to any given member, but not necessarily the last sale made or the last commission earned
         e. downline count
            i. number associated with every member that represents the number of downlines that member has
            ii. the sum of all the 1st generation downlines and their downline counts
      5. closing an account
         a. any outstanding profit sharing unit is cash out at the current price per unit to credit card
         b. any available credits is transfer to credit card
         c. any pending credits becomes the property of the upline
         d. all downlines along with all future commissions are given to the upline
II. Email Ads (referral tracking)
   A. means by which a user promotes a listing to another user, but neither needs to be a member
   B. if the email ad originates from a member then this member will be compensated depending on what action the recipient makes through the ad
   C. reflect sales rep ID, non-member price and member price (if commissioned)
   D. options for non-members
      1. sign up only (establish the referring member as upline)
      2. buy only (grant the commission to the referring member)
      3. sign up and buy at member price
         a. receive commission
         b. establishing the referring member as upline
   E. options for members
      1. buy now
         a. receive commission except for every preset number of sales
         b. establish the referring member as the new upline
      2. add to buy list
         a. automated purchases for every preset number of sales (optional activation)
         b. settings
            i. payment from credit card only
            ii. payment from available credits only
            iii. payment from all available credits first then credit card
            iv. number of profit sharing unit(s) to buy per sale (from zero up to limit)
      3. forward ad (establish a different sales rep ID)
III. Sales
   A. units of purchase such that each sale is equal to a listing, a posting, or an ad
   B. a sale can have more than one item or a combination of different products/services
   C. each sale carries a commission rather self made or not, direct or indirect, member or non-member purchase
      1. sales made counter shows the number of commission earned for every multiple integral number of sales
      2. the total sales counter records all commissions that an account has encounter
         a. direct sales counter registers those that are email ad type commissions
         b. indirect sales counter counts all the other commission types
   D. if necessary, the checkout will arrange the sale with the least sales price to be the preset number of sale
   E. a credit card is used for shopping unless a member has earned enough credits from the system
IV. Credits
   A. credits are split three ways from each sale
      1. a percentage of the sales price goes to the owner of the listing, plus any sales tax & shipping charge
      2. a percentage of the sales price is the commission which goes to the sales rep who is not on his preset number of sale
         a. every integral multiple number of commission belongs to the upline
         b. as credits flow through the upline, all members involved get compensation for the sale made
      3. a percentage of the sales price is the non-refundable transaction fee
   B. credits from each sale become available after the time allowed for the return expires
      1. non-commission based credits are recorded in the listing revenues counter
      2. commission based credits are recorded to total sales monetary counter either as
         a. direct sales monetary counter for all email ad type commissions
         b. indirect sales monetary counter for all other commission types
   C. pending credits are deducted as returns are made within the time allowed for the return
      1. a counter showing the total sum of all sales (commissions & non-commissions)
      2. a list with each entry showing
         a. transaction ID
         b. type of commission or otherwise non-commission
         c. time of availability
         d. the amount in monetary units
   D. members can choose to cash out any amount of their available credits at anytime
V. Returns
   A. a percentage of the sales price is the non-refundable transaction fee
   B. the owner of the listing and the member who received the commission (who can also be the owner of the listing) will return the pending credits
   C. a percentage of the sales price, plus any tax & shipping, either goes back to the member as available credits or credits back to the credit card of a non-member
   D. the time allowed for the return is depended on the delivery time and the length of the return policy plus a short grace period
VI. Profit Sharing (optional feature of the system)
A. a member making a purchase has the option to buy up to a predetermined number of unit(s) per sale at the on going price
   1. a counter reflecting the total number of units brought
   2. a counter revealing the total investments
   3. a counter recording the total value of expired units
   4. a counter showing the total number of units outstanding
   5. a list with entries
      a. the time the unit was brought
      b. the time the unit will become available credits
B. the cost is added to the purchase and payment can come from available credits or from credit card
C. the price per unit starts at a small predetermined amount and splits after a higher predetermined amount, at which time the price drops and the number of outstanding units increases
D. the life of each unit is limited, at which time it will automatically be paid out at the current price from the profit sharing account to available credits
E. the profit sharing account holds credits that the company has allocated to share aside from the regular account that holds the remaining income generated by the company
F. the profit sharing account consists of a percentage of the listing fees, transaction fees, and all profit sharing investments
G. an investment is the cost to own unit(s)
H. the price per unit can only increase as it is determined by the profit sharing account balance divided by the number of outstanding units,

$$price / unit = \frac{listing fees + transaction fees + profit sharing investments}{number of outstanding units}$$
VII. Checkout (with profit sharing feature)
   A. remove any inactive sale from the list & informs buyer
   B. first check to see if there is any sale left on the list before proceeding
   C. total up all sales by adding the non-member price to any tax & shipping charges
   D. check for membership
      1. non-member
         a. deduct sum from credit card
         b. credit profit sharing account
      2. member
         a. multiply the number of sales on the list by the maximum number of units allowed for each one sale
         b. wait for an input by the member which cannot be greater than the number resulted from the previous step
         c. multiply the input by the current price per unit to get the investment
         d. add the investment to the total for the sales on the list
         e. choice of payment
            i. deduct sum from available credits
            ii. deduct sum from credit card
         f. credit profit sharing account
   E. second check to see if there is any sale left on the list before proceeding
   F. identify sale by adding the number of sales on the list to the number of sales made (which is zero for non-members)
      1. if the sum is less than or equal to the preset number of sales, then the system identifies the sale with the highest sales price
      2. if the sum is greater than the preset number of sales, then subtract the number of sales made from the preset number of sales
         a. if the result is one, then the system identifies the sale with the least sales price
         b. if the result does not equal to one, then the system identifies the sale with the highest sales price
   G. if the company keeps a portion of the transaction fee, then transfer a percentage of the sales price (less than the percentage designated as the transaction fee) from the profit sharing account to the company's account
   H. transfer a percentage of the sales price plus any sales tax and shipping charges from the profit sharing account to the owner of the listing
      1. add to pending credits
      2. tag transaction for possible return
   I. withdraw from the profit sharing account a percentage of the sales price for commission
   J. set commission to email type if there is a referring member
   K. check buyer's membership
      1. non-member
         a. if commission is email type
            i. deposit commission to referring member's pending credits & tag transaction for possible return
            ii. add one to referring member's total sales counter
            iii. delete sale from list
            iv. proceed back to see if there is any more sale on list (back to 2nd check)
         b. if commission is not email type
            i. deposit commission to company's pending credits & tag transaction for possible return
            ii. add one to company's total sales counter
            iii. delete sale from list
            iv. proceed back to see if there is any more sale on list (back to 2nd check)
      2. member
         a. add investment if any to the total investments counter
         b. add input number if any to total units brought counter
         c. add input number of entries if any to profit sharing units counter
         d. reset investment and input number to zero
         e. if commission is email type, then change upline to referring member
         f. if the number of sales made equals the preset number of sales, then reset the sales made counter to zero
         g. add one to the total sales counter
         h. add one to the sales made counter
            i. if the sales made number does not equal to the preset number of sales
            (1) if commission is loop type, then add one to the indirect sales counter
            (2) add commission to pending credits & tag transaction for possible return
            (3) delete sale from list
            (4) proceed back to see if there is any more sale on the list (2nd check)
            ii. if the sales made number equals to the preset number of sales
            (1) if commission is loop type, then add one to the indirect sales counter
            (2) identify upline
            (3) change commission type to loop type unless commission type is email type
            (4) change commission type to upline type unless commission type is loop type
            (5) repeat all steps starting from the step that checks rather or not the sales made counter need a reset

An e-commerce company 26 that unites businesses and individuals online to promote each other for monetary rewards based on sales volume and profit sharing is definitely a new and exciting method of network marketing.

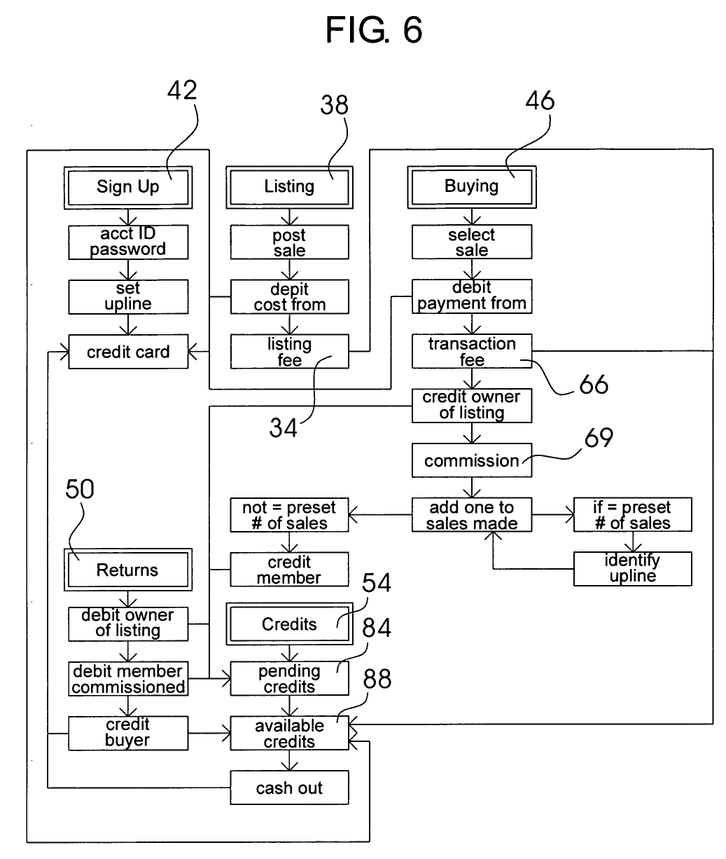

The following reference numerals are used on FIGS. 1 through 6:

10 member

10a listing member

10b non-listing member

14 non-member

18 upline or upline member

22 downline or downline member

26 company

30 email ad

34 listing fee

38 steps to list an item for sale

42 steps to sign up in the system

46 steps to buy an item listed for sale

50 steps to return an item purchased through the system

54 steps necessary to handle credits

58 steps necessary for optional profit sharing feature

62 steps of checkout process

66 transaction fee

69 commission

72 units

76 profit sharing account

84 pending credits

88 available credits

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A system for promoting sales comprising the steps of:
a) setting up a company;
b) setting up a means for users (members and non-members) of the system to communicate;
c) allowing a non-member to become a member of said company;
d) assigning a preset number of sales;
e) allowing a listing member to list an item for sale on said system; said listing including at least a price;
f) allowing said non-listing member, said non-member, and said listing member to forward said listing to a receiving member and a receiving non-member; whereby said non-listing member and said listing member become sending members;
g) allowing one of said non-listing member, said non-member, said listing member, said receiving member and said receiving non-member to purchase said item; whereby whoever buys said item becomes a buying member or a buying non-member;
h) making the sending member, who forwarded said listing to said buying member the upline of said buying member, if the sale is made as a result of the forwarded listing;
i) charging said buying member or said buying non-member the price for said item;
j) counting the number of sales made by each member;
k) paying a commission to said buying member if said number of sales made by said buying member is not an integer multiple of said preset number of sales;
l) paying a commission to said buying member's upline if said number of sales made by said buying member is an integer multiple said preset number of sales;
m) paying a commission to said buying member's upline's upline if said number of sales made by said buying member's upline is an integer multiple said preset number of sales; and
n) crediting said listing member for said sale; said credit being equal to said price minus said commission and said transaction fee.

2. A system as claimed in claim 1 further comprising the steps of:
a) charging said listing member a listing fee for listing said item for sale; and
b) paying said listing fee to said company.

3. A system as claimed in claim 1 further comprising the steps of:
a) charging said buying member or said buying non-member a transaction fee for purchasing said item; and
b) paying said transaction fee to said company.

4. A system as claimed in claim 1 further comprising the steps of:
a) allowing said listing member to have a return policy for said item; said return policy including at least a duration;
b) holding the revenues from said listing by said company for said duration;
c) allowing said buying member or said buying non-member to return said item, providing said buying member or said buying non-member has complied with said return policy;
d) debiting said commission from said buying member if said number of sales made by said buying member was not an integer multiple of said preset number of sales at the time the purchase of said item was originally made;
e) debiting said commission from said buying member's upline if said number of sales made by said buying member was an integer multiple of said preset number of sales at the time the purchase of said item was originally made;
f) debiting said commission from said buying member's upline's upline if said number of sales made by said buying member's upline was an integer multiple of said preset number of sales at the time the purchase of said item was originally made;
g) debiting said listing member for said return; the debit being equal to said price minus said commission and said transaction fee; and
h) crediting said buying member or said buying non-member said price minus said transaction fee for said return.

5. A system as claimed in claim 1 further comprising the steps of:
a) setting up a profit sharing account;
b) setting the maximum number of profit sharing units available with each sale;
c) setting a time period for profit sharing units;
d) allowing said buying member, to purchase up to the maximum number of profit sharing units with each sale; the product of the number of units purchased and the current price per unit being an investment;
e) paying said investment into said profit sharing account;
f) keeping track of the profit sharing units held by each member;
g) continuously calculating the price per unit; and
h) at the end of said time period, paying each member from said profit sharing account the product of the number of units held by the current price.

6. A system as claimed in claim 5 further comprising the steps of:
a) setting a percentage; and
b) paying said percentage of said listing fee into said profit sharing account with the remainder, if any, going to said company.

7. A system as claimed in claim 5 further comprising the steps of:
a) setting a percentage; and
b) paying said percentage of said transaction fee into said profit sharing account with the remainder, if any, going to said company.
